(19) United States
(12) Patent Application Publication
(10) Pub. No.: US 2010/0204428 A1
(43) Pub. Date: Aug. 12, 2010

(54) Process and Composition for the Preparation of Transparent Polyurethanes and Polyurethanes Obtained Therefrom

(76) Inventor: Pierino Barbieri, Corte De Frati (IT)

Correspondence Address: NIXON & VANDERHYE, PC, 901 NORTH GLEBE ROAD, 11TH FLOOR, ARLINGTON, VA, 22203, US

(21) Appl. No.: 11/989,948

(22) PCT Filed: Aug. 4, 2005
(86) PCT No.: PCT/IT2005/000470

§ 371 Date: Mar. 30, 2010

(51) Int. Cl. C08G 18/10

(52) U.S. Cl. 528/60

(57) ABSTRACT

A process for the preparation of transparent polyurethanes is disclosed, comprising step a) of preparing a prepolymer by reaction of one or more aliphatic or cycloaliphatic isocyanates, having two or more isocyanate groups, and one or more polyhydroxy compounds, having two or more hydroxy groups and a molecular weight ranging from 150 to 2000, step b) of preparing a composition comprising one or more polyhydroxy compounds, having two or more hydroxy groups and a molecular weight ranging from 150 to 2000 and a functionality from 2 to 5, and a suitable catalyst, and step c) of reacting the so-obtained prepolymer with the composition of step b), wherein at the end of step a) the percentage of free isocyanate groups in the prepolymer is at least 15%. In the preferred disclosed process, the percentage of free isocyanate groups in the prepolymer is from 15 to 30%. Particularly, a composition for the preparation of transparent polyurethanes and polyurethanes obtainable by said process are disclosed.

The present invention concerns a process for the preparation of polyurethanes which are rigid or semi-rigid, optically transparent, highly impact and heat resistant Particularly, the invention concerns new polyurethanes which are obtained by such a process.

Among plastic materials known for their optical properties, polycarbonates and polyurethanes are presently used for the preparation of transparent articles to visible light.

Polycarbonates have found application in several optical fields because of their shown good impact resistance together with their high transparency. Among them, particularly in ophthalmic application, the polycarbonate obtained by polymerizing diethyleneglycol bisallylcarbonate, also called organic glass or hard resin, has found application. However, in order to produce homogeneous articles from ADC, long casting procedures of 12 to 30 hours and the use of peroxides are needed Furthermore, such a polycarbonate shows volume shrinkage during curing of around 10%, which makes it not very suitable to form transparent articles having complex shapes.

Transparent polyurethanes are likewise known, as obtained by reacting an isocyanate derivative with an aromatic amine The document WO 03/044071 discloses the reaction of a prepolymer obtained by reacting an isocyanate and a polyol with an amino polymerizing agent, such as 4,4′-methylenbis-3-chloro-2,6-diethylaniline The polyureaurethane described in the document, although used in optical industry because it shows good properties of both chemical and mechanical resistance, as well as good properties of transparency, shows difficult machinability and poor dyeability Furthermore, the aromatic amines have environmental problems, since they are deemed to be potentially cancerogenous. Transparent parts or objects made of polyurethanes obtained through the use of aliphatic isocyanates and aromatic amines produce indeed unpleasant fumes and smells, in particular when subjected to mechanical tooling like surfacing, grinding, drilling and polishing. Moreover, during the mechanical processing, for instance during surfacing or grinding, the tools used must be continuously cleaned since the chips produced block or “soil” the tools themselves.

An object of the present invention is therefore to provide a process for the preparation of polyurethanes having superb optical characteristics, machinability and dyeability properties of the polycarbonates, but having at the same time good mechanical properties.

A further object of the invention is to provide a process which allows brief casting times and a scarce polymeric shrinkage during curing.

The above objects have been reached through a process as indicated in Claim 1.

The process for the preparation of polyurethanes according to the invention provides for the following steps:

a) preparing a prepolymer by reacting one or more aliphatic or cycloaliphatic isocyanates having two or more isocyanate groups with one or more polyhydroxy compounds having two or more hydroxy groups and a molecular weight ranging from 150 to 2000;

b) preparing a composition comprising one or more polyhydroxy compounds having two or more hydroxy groups, a molecular weight ranging from 150 to 2000 and functionality from 2 to 5 and a suitable catalyst;

c) reacting the prepolymer of step a) with the composition of step b),

wherein at the end of step a), the percentage of free isocyanate groups in the prepolymer is at least 15%.

The invention will be now described in details referring to some embodiments, which are here provided for exemplificative and non-limitative purposes.

At the end of step a), the percentage of free isocyanate groups is at least 15%. Preferably, such a percentage can range from 15 to 30%, more preferably, from 20 to 25%.

The prepolymer of step a) of the process according to the invention is preferably obtained by using one or more cycloaliphatic isocyanates selected from the group consisting of 4,4′-methylenbis(cyclohexylisocyanate), isophorone diisocyanate, 2,5(6)-diisocyanato-methylbicyclo(2.2.1)heptane and bis(isocyanate methyl)cyclohexane. Preferably, the cycloaliphatic isocyanate is 4,4′-methylenbis(cyclohexylisocyanate) or isophorone diisocyanate, more preferably, 4,4′-methylenbis(cyclohexylisocyanate).

The polyhydroxy compounds of step a) and step b) have, preferably and independently from each other, a molecular weight from 150 to 1000, and more preferably from 150 to 800.

The polyhydroxy compounds of step a) and step b) can be the same or different and are independently from each other selected from the group consisting of polyester polyols, caprolactone polyols, polyether polyols, amino polyols and polycarbonate polyols.

When such polyhydroxy compounds of step a) or step b) or both are polyester polyols, they can be, independently from each other, low molecular weight polyols having from 2 to 10 carbon atoms, such as ethylene glycol, propylene glycol, diethylene glycol, 1,4-butanediol, neopentylglycol, 1,6-hexanediol, esterified by one or more carboxylic acids having from 4 to 10 carbon atoms, such as adipic acid, succinic acid and sebacic acid. Preferably, the polyester polyol of the invention has a molecular weight from 400 to 1000, more preferably, about 1000. The preferred polyester polyol is a polyol having 2-10 carbon atoms esterified by adipic acid, more preferably, it is ethylene glycol and/or diethylene glycol esterified by adipic acid. Particularly, suitable compounds of the invention are, for instance, ethylene-diethylene glycol adipate commercially available as Bester 48® (PM=1000) from Rohm and Haas, or as Realkyd 10D10® (PM=1000) from Cray Valley.

When the polyhydroxy compounds of step a) and step b) of both are a polycaprolactone polyol, they can be, independently from each other, a product of the reaction of epsilon-caprolactone with a low molecular weight polyol having from 2 to 20 carbon atoms. Preferably, the polycaprolactone polyol of the invention has a molecular weight from 400 to 600, more preferably, from 500 to 550. More preferably, such a product of the reaction of epsilon-caprolactone is a product of the reaction of epsilon-caprolactone with diethylene glycol, called 2-oxepanone. Suitable polycaprolactone polyols are: the polycaprolactone polyol purchased as Capa 2054® (PM=550) by Solvay, and the polycaprolactone polyol purchased as Tone 0201® (PM=530) by Dow Chemical.

When the polyhydroxy compounds of step a) and step b) of both are a polyether polyol, they can be, independently from each other, one or more from polytetramethylene glycol (PTMG), trimethylolpropane ethoxylated and a product of condensation of ethylene oxide and/or propylene oxide having a molecular weight from 200 to 1000. More preferably, the polyether polyol is a product of condensation of ethylene oxide and/or propylene oxide with starter of glycerine and trimethylolpropane having molecular weight from 200 to 600. Still more preferably, the polyether polyol is a polyoxyalkylenetriol having molecular weight of about 300, obtained by a starter of trimethylolpropane and propylene oxide. Suitable compounds are: polyoxyalkylenetriol obtained by a starter of trimethylolpropane purchased as Demosphen 550U® (PM=450) by Bayer, as Polyether V531® (306) by ditta Bayer, as Demosphen 4011® (PM=306) by Bayer, as Multranol 4011® (PM=306) by Mobay, as Poly G 30-565® by Arch Chemical; glycerine propoxylate polyether polyol purchased as Voranol CP 450® (PM=450) by Dow Chemical; glycerine-based polyoxyalkylenetriol purchased as Alcupol C 6010® (PM=300) by Repsol; as Adeka g-300® (PM=300) by Adeka, as Voranol CP300® (PM=300) by Dow Chemical, as Jeffol G 30-240® (PM=300) by Huntsmann, as Lupranol 3530® (PM=300) by Basf; trimethylolpropane ethoxylated purchased as Polyol TP08® (PM=170) by Perstorp.

When the polyhydroxy compounds of step a) and step b) of both are a polyamino polyol, they can be one or more amino polyol of an aliphatic tertiary amine C3-C30 or aliphatic tertiary polyamine C3-C30. Preferably, the amino polyol has a functionality from 3 to 5 and has a molecular weight from 200 to 400, or more preferably, it is N,N,N′,N′-tetrakis(2-hydroxypropyl)ethylene diamine. Example of amino polyol is N,N,N′,N′-tetrakis(2-hydroxypropyl)ethylene diamine purchased as POLY-Q®40-800 (PM290) by Arch Chemicals.

When the polyhydroxy compounds of step a) and step b) of both are a polycarbonate polyol, they can preferably be an aliphatic polycarbonate polyol obtained by the esterification of dimethylcarbonate with a diol of 5-10 carbon atoms, still more preferably a product of the esterification of dimethylcarbonate with 1,6-hexanediol. Preferably, the polycarbonate polyol has a molecular weight from 600 to 900, more preferably from 750 to 850. Suitable examples are polyalkylenecarbonate diol purchased as Ravecarb 104® (PM=760) by Polimeri Europa or as Placcel CD 208 HL® (PM=800) by Daicel Chemical.

The functionality of the polyhydroxy compound of step b) according to the invention is from 2 to 5, preferably from 3 to 5.

Advantageously in step a) one or more polyols selected from the group consisting of polycarbonate polyol having a molecular weight from 200 to 800 and polyether polyol having a molecular weight from 150 to 500, while in step b) either a polyether polyol having a molecular weight from 150 to 500 or a mixture of a polyether polyol having a molecular weight from 150 to 500 and an amino polyol having molecular weight from 200 to 400 is present. More advantageously, said polyether polyol of step a) is a polyol having a molecular weight of about 300 and a functionality of 3 and one or more polyhydroxy compounds of step b) are either a polyether polyol of molecular weight of about 300 and a functionality of 3 or a mixture of a polyether polyol and a amino polyol with molecular weights from 220 to 360 and a functionality from 3 to 5. Still more advantageously, the polyether polyol of step b) is polyoxyalkylene triol, obtained by the condensation of propylene oxide with a starter of trimethylolpropane and the polyhydroxy compounds of step b) are a mixture of polyoxyalkylene triol, obtained by the condensation of propylene oxide with starter of trimethylolpropane, and N,N,N′,N′-tetrakis(2-hydroxypropyl)ethylenediamine.

In step c), the prepolymer of step a) and the ingredients of step b) react. The ratio by weight between the resulting prepolymer of step a) and the ingredients of step b) is preferably from 1:1 to 3:1.

The catalyst of step b) can be an amine or metal catalyst. Among amine catalysts, triethylene diamine, triisopropanol amine and diethanol amine can be cited. Among metal catalysts, tin, zinc, bismuth, titanium, zirconium and mercury derivatives and salts thereof, such as dibutyl tin dilaurate, bismuth nitrate, zinc naphtenate, 2-propanoate titanium, tris(3,6-diaza)hexanoate, phenylmercury neododecanoate, bismuth neodecanoate, zinc neodecanoate. Suitable catalysts according to the invention are: dibutyl tin dilaurate purchased as Dabco T12® by Air Products, phenylmercury neododecanoate purchased as Thorcat 535® by Thor Especialidades, bismuth neodecanoate purchased as Neobi 200® by Shepherd Chemical, zinc 19% neodecanoate purchased as Bicat ZM® by Sheperd Chemical.

Before implementing step c), additives can be added to the polyhydroxy compounds of step b) or to the prepolymer of step a) or to both. Advantageously, such additives are internal release agents or lubricants, blue and violet blueing agents, dyes, nanoparticles, UV absorbers (e.g. benzotriazoles as Tinuvin 571® from Ciba), stabilizers such as HALS (Hindered amine light stabilizer) purchased as Tinuvin 292® by Ciba, antioxidants (e.g. Irganox 1135® from Ciba).

The release agents are preferably one or more elements selected from fluoropolymer, di-n-alkyl-phosphate, polydimethyl-siloxane, alkanol acid phosphate, ammonium salt, mono-dialkylester phosphate, alkyltiophosphate, that can be added to the reaction mixture of formation of the prepolymer in step a), to the polyhydroxy compounds of step b), or to both. More preferably, the release agents are selected from the group consisting of di-n-butyl phosphate, polydimethyl-siloxane, dodecanol acid phosphate, diisopropyl acid phosphate, trimethylammonium chloride, mono-dialkylester phosphate, methyltiophosphate, trimethylcetylammonium chloride, dimethyltiophosphate, diethyltiophosphate, dimethylditiophosphate, dipropyltiophosphate, butylethylphosphate and laurilalcoholphosphate polyglycolether. Still more preferably, the release agent is one of di-n-butyl phosphate and mono-dialkylester phosphate. Examples of release agents; commercially available and suitable for the invention, are: Unidain DS-403® from Daikin (fluoropolymer), Unidain DS-401® from Daikin (fluoropolymer), 3-Q2-120® from Dow Chemical (polydimethylsiloxane), Int1681 OG® from Axel (mono-dialkylester phosphate), F-Top EF 122 A® from Shin Akite (fluoropolymer), F-Top EF 126® from Shin Akite (fluoropolymer), 10-F-Top 301® from Shin Akite (fluoropolymer), Unidain ODS-401® from Daikin (fluoropolymer), 13-Gafac RD510® from Toho Kagaku Kogyo (laurilalcoholphosphate-polyglycolether), Specialty 113® (mono-dialkylester phosphate) from Specialproducts Company, 21-JP-506® from Johoku Kagaku (butylethylphosphate), Zelec UN® from Stepan Company (alcohol phosphate neutralized, acidic form).

The lubricants are preferably alkylphosphates or fluoro non-ionic surfactants.

The synthesis of the prepolymer of step a) occurs between isocyanate and polyhydroxy compounds, preferably, at temperatures from 90 to 110° C., by adding the polyhydroxy compounds of step a) in two o more subsequent steps. Preferably, the first addition of the polyhydroxy compounds consists of about ⅔ of polyhydroxy compounds of step a), whereas the remaining ⅓ is added as second addition. At the end of step a), preferably, the content of the monomer in the reaction vessel is lower than 0.1%.

The above-mentioned additives are preferably added to polyhydroxy compounds of step b), before contacting the prepolymer of step a). The composition of step b) is heated at temperatures from 40 to 100° C.

The reaction of step c) preferably occurs at temperatures from 50 to 150° C.

In a preferred embodiment of the process according to the invention as claimed in Claim 30, the prepolymer is obtained by the reaction of 4,4′-methylenbis(cyclohexylisocyanate) with one or more polyhydroxy compounds of step a) selected from the group consisting of polyalkylenecarbonate diol having molecular weight from 600 to 800 and polyoxyalkylenetriol having molecular weight from 200 to 400, and one or more polyhydroxy compounds of step b) are selected from the group consisting of polyoxyalkylenetriol having molecular weight from 200 to 400 and trimethylolpropane ethoxylated.

In a more preferred embodiment as referred in Claim 32, one or more polyhydroxy compounds of step a) and step b) are as indicated in Claim 30 and said one or more polyhydroxy compounds of step b) or of both step a) and step b) are added with an internal release agent consisting of mono-dialkylester phosphate.

In the embodiments of the invention as indicated in Claim 30 and Claim 32, the percent content of free isocyanate groups at the end of step a) is preferably equal or higher than 20%, more preferably is about 25%.

In such preferred embodiments, the prepolymer is reacted with one or more polyhydroxy compounds in a preferred ratio in the range from 3:1 to 1.5:1 of prepolymer to ingredients of step b), more preferably 1.7:1 when the polyol of step b) is polyoxyalkylenetriol having molecular weight of about 300, 2.1:1 when the polyols of step b) are a mixture of polyoxyalkylenetriol having molecular weight of about 300 and trimethylolpropane ethoxylated, and 3:1 when the polyol of step b) is trimethylolpropane ethoxylated.

The catalyst of the composition of step b) in the preferred embodiments is preferably selected from the group consisting of tin dibutyldilaurate, phenylmercuryneodecanoate, butyltitanate, bismuth neodecanoate, zinc neodecanoate; more preferably it is phenylmercuryneodecanoate.

Therefore, polyurethane of the invention is obtained by combining the prepolymer of step a) with the composition of step b) in suitable conditions of temperature. In a further aspect, hence, the invention concerns a composition for the preparation of polyurethanes as indicated in Claim 36 through catalytic polymerization comprising:
part a): a prepolymer obtained by reacting one or more isocyanates and one or more polyhydroxy compounds having molecular weight from 150 to 2000 and having a percentage of free isocyanate groups of at least 15%; and
part b): one or more polyhydroxy compounds having molecular weight from 150 to 2000 and having a functionality from 2 to 5 and a catalyst.

In the composition for the polymerization by means of catalyst, part a) corresponds to the ingredients of step a) of the process of the invention, whereas part b) corresponds to the ingredients of step b) of the process of the invention.

The definitions of said one or more polyhydroxy compounds of part a) and part b), as well as the additives, catalysts and preferred embodiments are the same as the above-described process.

In a still further aspect, the invention concerns a polyurethane obtainable by the process of the invention as indicated in Claim 40.

The polyurethane of the present invention is a transparent polymer having a light transmission of at least 80% of the incident light, preferably higher than 90% of the incident light.

Moreover, such a polyurethane shows an extraordinarily good colour, thus essentially having colour like water-white with yellow indexes lower than those known in the prior art. It is believed that this extraordinary colour property is due to the optimal resistance to the reaction of the air oxygen. In fact, in the case of prior art polycarbonates, such as the polymer obtained by the polymerization of diethylene glycol bisallyl carbonate (ADC), the oxygen inhibition causes incomplete polymerization, whereas in the case of polyurethanes obtained by aromatic amines, oxygen reacts with amine moieties, thus giving a visible yellowing to the final polyurethane. On the contrary, in the case of polyurethanes according to the invention the yellow index is extremely low.

Furthermore, polyurethanes of the invention have a heat distortion temperature (HDT) which lies in the range of 60-110° C. as the transparent polyurethanes known in the prior art and obtained by aromatic amines, but, with respect to them, polyurethanes of the invention show good machinability properties, as it will be demonstrated in the following examples.

The polyurethanes according to the invention can be formed in polymeric articles for applications such as building or automobile windows, automobile headlamp covers, ophthalmic lenses, sun lenses, protective goggles, face shields, light guides, optical fibers, mobile phone components, lenses for optical storage devices, prisms, Fresnel lenses, display covers, solar cells, optical sensor covers, transparent pipes, and furniture, windows for cinemas and performances in general.

Such articles may be produced by several processes like casting, extrusion moulding or injection moulding or even through machine tooling from crude shapes of the final polymer.

The process of casting is generally carried out by using moulds, which may be made of all kinds of materials, such as glass or metal. Suitable metals can be stainless steel, nickel, aluminium, copper, chromium, silver and gold.

The process according to the invention, particularly in the preferred embodiments indicated in Claims 30 and 32, is advantageously suitable for the production of lenses. Preferably in this case, glass moulds are used. It was possible to verify that casting times can be reduced, even at low temperatures. As a matter of fact, e.g. temperatures of 50-80° C. in about 3-5 hours can be used to obtain optically homogeneous, semi-finished ophthalmic lenses of about 19 mm thickness. This is a great advantage with respect to the prior art, which, for instance, in the case of polycarbonate, such as the polymer obtained by the polymerization of diethylene glycol bisallyl carbonate (ADC) with diisopropylperoxydicarbonate, needs casting times of about four times longer (“Allyl carbonate ester polymers” Encyclopedia of Chem. Process. Des., Vol. 2, pages 452-460; Ed. McKetta, John J. E Cunnigham, William A. Dekker, New York, 1977). A further advantage of the process according to the invention, particularly for the preferred embodiments of Claim 30 or 32, is that the curing temperature in step c) can considerably be above 80° C. in order to cast articles with very low thickness, like about 0.01-7 mm. In these cases, at 110° C. the reaction times will be 20 minutes, whereas at 130° C. they will be about 4 minutes. According to the present invention, the curing in about 1 minute at temperatures of about 150° C. has been possible, without inducing yellowness in the polymer. Therefore, the present invention provides the possibility of using “fast-cast” systems, i.e. casting in very short time, where automated or robotized machines are used.

As widely explained below, a further advantage of the present invention is that the polymer according to the invention, particularly according to the preferred embodiments claimed in Claim 30 or 32, shows a volume shrinkage during curing lower than 2%, by making it suitable to the casting of complex shapes to be formed. For example, in the case of lens casting, with the polymer of the invention it is possible to obtain sophisticated lenses, such as bifocal, trifocal or progressive lenses, as well as high power lenses for ophthalmic application.

The transparent polyurethane according to the invention, in addition to show good mechanical and chemical properties, by not providing the use of aromatic amines, has less environmental impact. The handling of compounds used in the production of polyurethanes and the machining from polyurethanes to articles are indeed improved with respect of the prior art polyurethanes, since according to the invention there are no fumes or emissions of smells and/or toxic substances of any kind.

With respect to transparent polyurethanes produced with the method of aromatic amines, it is also pointed out that, under mechanical processing for the formation of articles, the polyurethanes of the present invention produce chips which do not block and/or soil tools.

Therefore the polyurethanes according to the invention show exceptional optical properties and, with respect to the prior art polycarbonates, show improved mechanical properties, such as higher impact resistance and better hardness.

Some examples of preparation of the polyurethanes according to the invention now follow, as well as an evaluation of the obtained polymers. In all the examples, the amounts of indicated ingredients are expressed by weight.

### EXAMPLE 1

### General Preparation of the Prepolymer of Step a)

The following isocyanates were used:
isophorondiisocyanate, purchased as Desmodur I® by Bayer AG;
4,4′-methylenbis(cyclohexylisocyanate), purchased as Desmodur W® by Bayer AG;

and the following polyhydroxy compounds:
2-oxepanone, obtained by the reaction of epsilon-caprolactone and diethylene glycol and purchased as Capa 2054® by Solvay, having molecular weight of 550 and a functionality of 2, briefly indicated as “PCL PM550”;
ethylene-diethylene glycol adipate, obtained by esterification of adipic acid with diethylene glycol and monoethylene glycol, having a molecular weight of 1000 and a functionality of 2, purchased as Bester 48® by Rohm and Haas, briefly indicated as “polyester PM1000”;
polyoxyalkylenetriol, obtained by condensation of propylene oxide and a starter of trimethylolpropane, having a molecular weight of 450 and a functionality of 3, purchased as Desmophen 550U® by Bayer, briefly indicated as “polyether PM450”;
polyalkylenecarbonate diol, obtained by the esterification of dimethyl carbonate with 1,6-hexanediol, having a molecular weight of 760 and a functionality of 2, purchased as Ravecarb 104® by Polimeri Europa, briefly indicated as “polycarbonate PM760”;
polyoxyalkylenetriol, obtained by condensation of propylene oxide and starter of trimethylolpropane, having a molecular weight of 306 and a functionality of 3, purchased as Desmophen 4011T® by Bayer, briefly indicated as “polyether PM306”.

An isocyanate between the above-mentioned compounds was mixed and reacted with a polyhydroxy compound, as above-referred, according to the Scheme and in the amounts (in grams) indicated in the following Table 1.

TABLE 1

| | | | PCL | Polyester | Polyether | Polycarbonate | Polyether |
|---|---|---|---|---|---|---|---|
| Prepolymer | Desmodur I | Desmodur W | PM550 | PM1000 | PM450 | PM760 | PM306 |
| 1 | 0 | 76 | 0 | 0 | 24 | 0 | 0 |
| 2 | 0 | 76 | 0 | 0 | 0 | 24 | 0 |
| 3 | 0 | 76 | 0 | 0 | 24 | 0 | 0 |
| 4 | 68 | 0 | 0 | 32 | 0 | 0 | 0 |
| 5 | 68 | 0 | 32 | 0 | 0 | 0 | 0 |
| 6 | 0 | 76 | 0 | 0 | 24 | 0 | 0 |
| 7 | 0 | 76 | 24 | 0 | 0 | 0 | 0 |
| 8 | 68 | 0 | 0 | 0 | 32 | 0 | 0 |
| 9 | 68 | 0 | 0 | 0 | 0 | 32 | 0 |
| 10 | 0 | 76 | 0 | 0 | 24 | 0 | 0 |
| 11 | 0 | 76 | 0 | 0 | 0 | 24 | 0 |
| 12 | 68 | 0 | 0 | 32 | 0 | 0 | 0 |
| 13 | 68 | 0 | 32 | 0 | 0 | 0 | 0 |
| 14 | 0 | 76 | 0 | 24 | 0 | 0 | 0 |
| 15 | 0 | 76 | 24 | 0 | 0 | 0 | 0 |
| 16 | 68 | 0 | 0 | 0 | 32 | 0 | 0 |
| 17 | 68 | 0 | 0 | 0 | 0 | 32 | 0 |
| 18 | 0 | 76 | 0 | 0 | 24 | 0 | 0 |
| 19 | 0 | 76 | 0 | 0 | 0 | 24 | 0 |
| 20 | 0 | 80 | 0 | 0 | 0 | 20 | 0 |
| 21 | 0 | 88 | 0 | 0 | 0 | 12 | 0 |
| 22 | 0 | 84 | 0 | 0 | 0 | 0 | 16 |
| 23 | 0 | 90 | 0 | 0 | 0 | 0 | 10 |

The reaction was carried out at 90° C., for a total period of 6 hours, under vacuum with stirring or under nitrogen blanketing. In the reaction vessel, an amount of 75% of a polyhydroxy compound of step a) was added in 4 hours and then slowly and with stirring the whole amount of isocyanate was added. The percentage of free NCO groups was monitored and the remaining amount of polyhydroxy compound was then added in 2 hours. At the end of the addition and of the further reaction, the percentage of free NCO groups (% NCO) was measured through the following method: a sample of 2-2.5 g of prepolymer in 25 ml of anhydrous toluol was dissolved and 20 ml of N-butylamine 2N was then added to such a solution. The mixture was heated under stirring for a few minutes. Hence the said mixture was cooled at room temperature and 50 ml of anhydrous methanol were added. A titration with hydrochloric acid 1N was performed until observing green-yellow colour of the bromophenol blue indicator. The blank titration, thus comprising all the reagents other than isocyanate, was then repeated. The result function was:

free % NCO=4.2×(B−T)×N/P

where B denotes cc_{HCl} used for the blank titration;

T denotes cc_{HCl} used for the titration of isocyanate;

N denotes the normality of HCl;

P denotes the exact weight of sample.

The percentage of free isocyanate groups was resulted from 15 to 25%, specifically for each prepolymer was as follows:

| | % NCO |
|---|---|
| Prepolymer 1: | 18 |
| Prepolymer 2: | 22 |
| Prepolymer 3: | 18 |
| Prepolymer 4: | 22 |
| Prepolymer 5: | 20 |
| Prepolymer 6: | 18 |
| Prepolymer 7: | 20 |
| Prepolymer 8: | 16 |
| Prepolymer 9: | 22 |
| Prepolymer 10: | 18 |
| Prepolymer 11: | 22 |
| Prepolymer 12: | 22 |
| Prepolymer 13: | 20 |
| Prepolymer 14: | 22 |
| Prepolymer 15: | 20 |
| Prepolymer 16: | 16 |
| Prepolymer 17: | 22 |
| Prepolymer 18: | 18 |
| Prepolymer 19: | 22 |
| Prepolymer 20: | 23 |
| Prepolymer 21: | 26 |
| Prepolymer 22: | 20 |
| Prepolymer 23: | 25 |

Once the prepolymer was obtained, the extraction of the monomer was then carried out, so that the monomer amount was, in any case, lower than 0.1% in the final prepolymer.

### EXAMPLE 2

### Preparation of Ingredients of Step b)

The following polyhydroxy compounds were used:
2-oxepanone, obtained by the reaction of epsilon-caprolactone and diethylene glycol and purchased as Capa 2054® by Solvay, having a molecular weight of 550 and a functionality of 2, briefly indicated as “PCL PM550”;
ethylene-diethylene glycol adipate, obtained by esterification of adipic acid and diethylene glycol and monoethylene glycol, having a molecular weight of 1000 and functionality of 2, purchased as Bester 48® by Rohm and Haas, briefly indicated as “polyester PM1000”;
polyalkylenecarbonate diol, obtained by the esterification of dimethyl carbonate with 1,6-hexanediol, having a molecular weight of 760 and a functionality of 2, purchased as Ravecarb 104® by Polimeri Europa, briefly indicated as “polycarbonate PM760”;
polyoxyalkylenetriol, obtained by condensation of propylene oxide and a starter of trimethylolpropane, having a molecular weight of 450 and a functionality of 3, purchased as Desmophen 550U® by Bayer, briefly indicated as “polyether PM450”;
polyoxyalkylene triol, obtained by condensation of propylene oxide and a starter of trimethylolpropane, having a molecular weight of 306 and a functionality of 3, purchased as Desmophen 4011T® by Bayer, briefly indicated as “polyether PM306”.
N,N,N′,N′-tetrakis(2-hydroxypropyl)ethylenediamine, purchased as Poly Q® 40-800 by Arch Chemical, briefly indicated as “amino polyol PM290”.

A catalyst, specifically dibutyl tin dilaurate, a blueing agent, specifically violet pigment C.I. 23 dispersed in 10% of polyether, and an internal release agent, specifically mono-dialkylester phosphate purchased as Int 1681 OG® by Axel, were added to a polyhydroxy compound, or a mixture thereof, before contacting the prepolymer. The mixture was then heated at 105° C. for at least 4 hours, under vacuum and stirring.

The following amounts were used for the preparation of the ingredients of step b).

Polyhydroxy Composition A of Step b)

The polyhydroxy composition A was obtained by mixing 59 g of PCL PM550, 60 g of polycarbonate PM760, the catalyst, the release agent and the blueing agent in amount of 0.05 g, 1.9 g e 0.05 g, respectively.

Polyhydroxy Composition B of Step b)

The polyhydroxy composition B was obtained by mixing 94 g of polyester PM 1000, 25 g of polycarbonate PM760, the catalyst, the release agent and the blueing agent in amount of 0.05 g, 1.9 g e 0.05 g, respectively.

Polyhydroxy Composition C of Step b)

The polyhydroxy composition C was obtained by mixing 59 g of polyester PM1000, 60 g of polycarbonate PM760, the catalyst, the release agent and the blueing agent in amount of 0.05 g, 1.9 g e 0.05 g, respectively.

Polyhydroxy Composition D of Step b)

The polyhydroxy composition D was obtained by mixing 94 g of polyether PM450, 25 g of polycarbonate PM760, the catalyst, the release agent and the blueing agent in amount of 0.05 g, 1.9 g e 0.05 g, respectively.

Polyhydroxy Composition E of Step b)

The polyhydroxy composition E was obtained by mixing 59 g of polyether PM450, 60 g of polycarbonate PM760, the catalyst, the release agent and the blueing agent in amount of 0.05 g, 1.9 g e 0.05 g, respectively.

Polyhydroxy Composition F of Step b)

The polyhydroxy composition F was obtained by mixing 100 g of polyether PM450, 0.1 g of the catalyst, 2 g of the release agent and 0.01 g of the blueing agent.

Polyhydroxy Composition G of Step b)

The polyhydroxy composition G was obtained by mixing 100 g of polyether PM306, 0.1 g of the catalyst, 2 g of the release agent and 0.01 g of the blueing agent.

Polyhydroxy Composition H of Step b)

The polyhydroxy composition H was obtained by mixing 10 g of amino polyol PM290, 90 g of polyether PM306, 0.1 g of the catalyst, 2 g of the release agent and 0.01 g of the blueing agent.

Polyhydroxy Composition I of Step b)

The polyhydroxy composition I was obtained by mixing 20 g of amino polyol PM290, 80 g of polyether PM306, 0.1 g of the catalyst, 2 g of the release agent and 0.01 g of the blueing agent.

Polyhydroxy Composition L of Step b)

The polyhydroxy composition L was obtained by mixing 30 g of amino polyol PM290, 70 g of polyether PM306, 0.1 g of the catalyst, 2 g of the release agent and 0.01 g of the blueing agent.

Polyhydroxy Composition M of Step b)

The polyhydroxy composition M was obtained by mixing 40 g of amino polyol PM290, 60 g of polyether PM306, 0.1 g of the catalyst, 2 g of the release agent and 0.01 g of the blueing agent.

### EXAMPLE 3

### Preparation of the Polyurethanes

The prepolymers 1-23 obtained in Example 1 were cooled to 70° C. and poured in a first vessel.

The polyhydroxy compositions A-M obtained in Example 2 were cooled to 60° C. and poured in a second vessel.

The prepolymers 1-23 and the polyhydroxy compositions A-M were respectively reacted according to the scheme and in the amounts referred in Table 2 below and polyurethanes 1-31 were obtained:

TABLE 2

| Polyurethane | Amount of prepolymer | Polyhydroxy composition |
|---|---|---|
| 1 | 84 g of prep. 1 | A |
| 2 | 48 g of prep. 2 | B |
| 3 | 65 g of prep. 3 | C |
| 4 | 131 g of prep. 4 | D |
| 5 | 145 g of prep. 5 | D |
| 6 | 161 g of prep. 6 | D |
| 7 | 145 g of prep. 7 | D |
| 8 | 181 g of prep. 8 | D |
| 9 | 131 g of prep. 9 | D |
| 10 | 161 g of prep. 10 | D |
| 11 | 131 g of prep. 11 | D |
| 12 | 105 g of prep. 12 | E |
| 13 | 115 g of prep. 13 | E |
| 14 | 105 g of prep. 14 | E |
| 15 | 115 g of prep. 15 | E |
| 16 | 145 g of prep. 16 | E |
| 17 | 105 g of prep. 17 | E |
| 18 | 128 g of prep. 18 | E |
| 19 | 105 g of prep. 19 | E |
| 20 | 121 g of prep. 20 | F |
| 21 | 107 g of prep. 21 | F |
| 22 | 140 g of prep. 22 | F |
| 23 | 112 g of prep. 23 | F |
| 24 | 178 g of prep. 20 | G |
| 25 | 158 g of prep. 21 | G |
| 26 | 206 g of prep. 22 | G |
| 27 | 165 g of prep. 23 | G |
| 28 | 173 g of prep. 23 | H |
| 29 | 180 g of prep. 23 | I |
| 30 | 188 g of prep. 23 | L |
| 31 | 195 g of prep. 23 | M |

The obtained polyurethanes 1-31 were then poured in suitable moulds and kept at temperatures from 80 to 110° C. After 3 hours, the polyurethanes were completely hardened.

### EXAMPLE 4

### Evaluation of Polyurethanes 1-31

The heat distortion temperature (HDT) under load according to standard procedure ASTM D-648 and the light transmission according to standard procedure ASTM D-1003 were measured for each polyurethane 1-31. The values reported in Table 3 were obtained.

TABLE 3

| Polyurethane | HDT value | Light transmission |
|---|---|---|
| 1 | 60 | >90% |
| 2 | 60 | >90% |
| 3 | 60 | >90% |
| 4 | 60 | >90% |
| 5 | 60 | >90% |
| 6 | 62 | >90% |
| 7 | 62 | >90% |
| 8 | 64 | >90% |
| 9 | 64 | >90% |
| 10 | 65 | >90% |
| 11 | 66 | >90% |
| 12 | 66 | >90% |
| 13 | 66 | >90% |
| 14 | 68 | >90% |
| 15 | 68 | >90% |
| 16 | 70 | >90% |
| 17 | 70 | >90% |
| 18 | 73 | >90% |
| 19 | 71 | >90% |
| 20 | 60 | >90% |
| 21 | 63 | >90% |
| 22 | 66 | >90% |
| 23 | 68 | >90% |
| 24 | 71 | >90% |
| 25 | 75 | >90% |
| 26 | 79 | >90% |
| 27 | 99 | >90% |
| 28 | 100 | >90% |
| 29 | 102 | >90% |
| 30 | 105 | >90% |
| 31 | 106 | >90% |

Therefore the obtained polyurethanes showed excellent optical transparency properties and good heat resistance properties.

Particularly, the polyurethanes 24 and 25, obtained from a prepolymer, resulting from 4,4′-methylenbis(cyclohexyl isocyanate) and polycarbonate PM760, and, as polyhydroxy compound of step b), polyether PM306, showed good heat resistance properties. More preferably, the polyurethanes 26-31, obtained from a prepolymer, resulting from 4,4′-methylenbis(cyclohexyl isocyanate) and polyether PM306 as polyhydroxy compound of step a), and either polyether PM306 with functionality 3 as polyhydroxy compound of step b) or the mixture of polyether PM306 and amino polyol PM290, showed optimal heat resistance properties.

### EXAMPLE 5

### Comparative Test of Polyurethane 26

The polyurethane 26 was subjected to machinability tests in comparison to a transparent polyurethane obtained according to the prior art, i.e. by reaction with aromatic amines.

The two polyurethanes were subjected to three tests:

A) edging of cast lenses;

B) tinting by immersion;

C) hard coating.

The results are reported in the following Table 4:

TABLE 4

| | | Results according to the | Results according to the |
|---|---|---|---|
| | | invention | prior art |
| edging of cast lenses | Procedure: HRI type | Continuous chip | Continuous chip formation. |
| (Briot Machine) | (wet machining) | formation. | The strings roll up and need |
| | | The most part is removed | to be removed manually. |
| | | by water spray. | Strong unpleasant smell. |
| | Procedure: PC type | Few chips formed. | Better result than HRI type |
| | (dry machining) | No smell. | one. |
| | | Lens edge: even. | Same problems as before but |
| | | | to a less extent. |
| | | | Lens edge: some unevenness. |
| Tinting by | 70° C. | inhomogeneous | inhomogeneous |
| immersion | 80° C. | inhomogeneous | inhomogeneous |
| (BPI grey, 5 min) | Dye retention | Complete removal | Complete removal |
| | capability | | |
| | (one immersion in | | |
| | acetone) | | |
| | Chemical etching | none | none |
| | (NaOH, 100° C.) | | |
| Hard coating (SDC) | Appearance | Good optical | Acceptable optical |
| (standard coating for | | properties. | properties. |
| ADC lenses) | | No yellowing. | |
| curing for 4 hours, | | Original curvature | |
| 100° C. | | restored. | |
| | Adhesion | 100% | 100% |

As shown in Table 4, the transparent polyurethane of the present invention, when subjected to processing, produces a few chips which can be easily removed, contrary to the prior art polyurethane obtained by using aromatic amines, said prior art polyurethane producing chips which soil and block tools, when subjected to mechanical processing.

Furthermore, the polyurethane of the invention retained the colouring agent in a comparing way to the prior art polyurethane, but, with respect to the latter, the polyurethane of the invention did not yellow.

### EXAMPLE 6

### Preparation of Polyurethane 32 by the Process According to the Preferred Embodiment of the Invention

Step a) Preparation of the Prepolymer 24

84 g of 4,4′-methylenebis(cyclohexylisocyanate), commercially available as Desmodur W® from Bayer AG, were reacted with 16 g of polyalkylenecarbonate diol having a molecular weight of 760 and a functionality of 2, purchased as Ravecarb 104® by Polimeri Europa. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition N

97.5 g of polyoxyalkylenetriol having a molecular weight of 306 and a functionality of 3, obtained by the condensation of propylene oxide with a starter of trimethylolpropane and purchased as Desmosphen 4011®T by Bayer, were mixed with 2 g of internal release agent consisting in mono-dialkylester phosphate and purchased as Int 1681 OG® by Axel, 0.2 g of blueing agent (whose formulation was as follows: 10 g of Sandoplast Violetto RSB® from Clariant dispersed in 10 kg of Desmophen 4011®T from Bayer) and 0.3 g of catalyst consisting in phenylmercuryneodecanoate purchased as Thorcat 535® by Thor Especialidades. The obtained polyhydroxy composition N was then heated at temperature of 80° C. for at least 2 hours, under vacuum and stirring.

Step c) of Reaction of the Prepolymer 24 with the Polyhydroxy Composition N

The prepolymer 24 of step a) was then cooled to 60° C. and poured in a vessel. The polyhydroxy composition N, prepared as above indicated, was cooled to 60° C. and poured in a second vessel. The prepolymer 24 of step a) was successively reacted with the composition in a ratio by weight of 1.7:1 of prepolymer 24 with respect to the polyhydroxy composition N. The reaction mass was then poured in a suitable mould and brought to a temperature of 60-110° C. in two hours and maintained for 1 hour at 110° C. After about three hours from the beginning of the reaction, the polyurethane 32 was completely hardened.

### EXAMPLE 7

### Preparation of Polyurethane 33 by the Process According to the Preferred Embodiment of the Invention

Step a) Preparation of the Prepolymer 33

89 g of 4,4′-methylenebis(cyclohexylisocyanate), commercially available as Desmodur W® from Bayer AG, were reacted with 2 g of polyalkylenecarbonate diol having a molecular weight of 760 and a functionality of 2, purchased as Ravecarb 104® by Polimeri Europa, 7 g of polyoxyalkylenetriol of molecular weight of 306 and functionality of 3, obtained by the condensation of propylene oxide with a starter of trimethylolpropane and purchased as Desmosphen® 4011T by Bayer, 2 g of an internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition N and Step c) of Reaction of Prepolymer 25 and Polyhydroxy Composition N

The polyhydroxy composition N was prepared according to Example 6. The polyhydroxy composition N was then heated to a temperature of 80° C. for at least 2 hours, under vacuum and stirring.

The prepolymer 25 of step a) was then cooled to 60° C. and poured in a vessel. The polyhydroxy composition N prepared as above indicated was cooled to 60° C. and poured in a second vessel. The prepolymer 25 of step a) was successively reacted with the composition in a ratio by weight of 1.7:1 of prepolymer 25 with respect to the polyhydroxy composition N. The reaction mass was then poured in a suitable mould and brought to a temperature of 60-110° C. in two hours and maintained for 1 hour at 110° C. After about three hours from the beginning of the reaction, the polyurethane 33 was completely hardened.

### EXAMPLE 8

### Preparation of Polyurethane 34 by the Process According to the Preferred Embodiment of the Invention

Step a) Preparation of the Prepolymer 26

90 g of 4,4′-methylenebis(cyclohexylisocyanate), commercially available as Desmodur W® from Bayer AG, were reacted with 8 g of polyoxyalkylenetriol of molecular weight of 306 and functionality of 3, obtained by the condensation of propylene oxide with a starter of trimethylolpropane and purchased as Desmosphen® 4011T by Bayer, 2 g of internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1; as being about 25%. Once the prepolymer was obtained, the monomer was removed so that the related amount was lower than 0.1% in the prepolymer.

Step b) of Preparation of the Polyhydroxy Composition N and Step c) of Reaction of Prepolymer 26 and Polyhydroxy Composition N

The polyhydroxy composition N was prepared according to Example 6. The polyhydroxy composition N was then heated to a temperature of 80° C. for at least 2 hours, under vacuum and stirring.

The prepolymer 26 of step a) was then cooled to 60° C. and poured in a vessel. The polyhydroxy composition N prepared as above indicated was cooled to 60° C. and poured in a second vessel. The prepolymer of step a) was successively reacted with the composition in a ratio by weight of 1.7:1 of prepolymer 26 with respect to the polyhydroxy composition N. The reaction mass was then poured in a suitable mould and brought to a temperature of 60-110° C. in two hours and maintained for one hour at 110° C. After about three hours from the beginning of the reaction, the polyurethane 34 was completely hardened.

### EXAMPLE 9

### Preparation of Polyurethane 35 by the Process According to the Preferred Embodiment of the Invention

Step a) Preparation of the Prepolymer 27

84 g of 4,4′-methylenebis(cyclohexylisocyanate), commercially available as Desmodur W® from Bayer AG, were reacted with 16 g of polyalkylenecarbonate diol having a molecular weight of 760 and a functionality of 2, purchased as Ravecarb 104® by Polimeri Europa. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition, the percentage of free NCO (% NCO) was measured, through the method indicated in Example 1, as being about 25%. Once the prepolymer was obtained, the monomer was removed so that the related amount was lower than 0.1% in the prepolymer.

Step b) Preparation of the Polyhydroxy Composition P

67.5 g of polyoxyalkylenetriol having a molecular weight of 306 and a functionality of 3, obtained by the condensation of propylene oxide with a starter of trimethylolpropane and purchased as Desmosphen 4011®T by Bayer, were mixed with 30 g of trimethylolpropane ethoxylated having a functionality of 3, purchased as Polyol TP08® (PM170) by Perstorp, and 2 g of internal release agent consisting in mono-dialkylester phosphate and purchased as Int 1681 OG® by Axel, 0.2 g of blueing agent, whose formulation was as follows: 10 g of Sandoplast Violetto RSB® from Clariant dispersed in 10 kg of Desmophen 4011®T from Bayer, and 0.3 g of catalyst consisting in phenylmercuryneodecanoate purchased as Thorcat 535® by Thor Especialidades. The obtained polyhydroxy composition P was then heated at temperature of 80° C. for at least 2 hours, under vacuum and stirring.

Step c) of Reaction of the Prepolymer 27 with the Polyhydroxy Composition P

The prepolymer 27 of step a) was then cooled to 60° C. and poured in a vessel. The polyhydroxy composition P prepared as above indicated was cooled to 60° C. and poured in a second vessel. The prepolymer 27 of step a) was successively reacted with the composition in a ratio by weight of 2.1:1 of prepolymer 27 With respect to the polyhydroxy composition P. The reaction mass was then poured in a suitable mould and brought to a temperature of 60-110° C. in two hours and maintained for 1 hour at 110° C. After about three hours from the beginning of the reaction, the polyurethane 35 was completely hardened.

### EXAMPLE 10

### Preparation of Polyurethane 36 by the Process According to the Preferred Embodiment of the Invention

Step a) Preparation of the Prepolymer 28

89 g of 4,4′-methylenebis(cyclohexylisocyanate), commercially available as Desmodur W® from Bayer AG, were reacted with 2 g of polyalkylenecarbonate diol having a molecular weight of 760 and a functionality of 2, purchased as Ravecarb 104® by Polimeri Europa, 7 g of polyoxyalkylenetriol of a molecular weight of 306 and functionality of 3, obtained by the condensation of propylene oxide with a starter of trimethylolpropane and purchased as Desmosphen® 4011T by Bayer, 2 g of internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition P and Step c) of Reaction of Prepolymer 28 and Polyhydroxy Composition P

The polyhydroxy composition P was prepared according to Example 9. The polyhydroxy composition P was then heated to a temperature of 80° C. for at least 2 hours, under vacuum and stirring.

The prepolymer 28 of step a) was then cooled to 60° C. and poured in a vessel. The polyhydroxy composition P prepared as above indicated was cooled to 60° C. and poured in a second vessel. The prepolymer 28 of step a) was successively reacted with the composition in a ratio by weight of 2.1:1 of prepolymer 28 with respect to the polyhydroxy composition P. The reaction mass was then poured in a suitable mould and brought to a temperature of 60-110° C. in two hours and maintained for 1 hour at 110° C. After about three hours from the beginning of the reaction, the polyurethane 36 was completely hardened.

### EXAMPLE 11

### Preparation of Polyurethane 37 by the Process According to the Preferred Embodiment of the Invention

Step a) Preparation of the Prepolymer 29

90 g of 4,4′-methylenebis(cyclohexylisocyanate), commercially available as Desmodur W® from Bayer AG, were reacted with 8 g of polyoxyalkylenetriol of molecular weight of 306 and functionality of 3, obtained by the condensation of propylene oxide with starter of trimethylolpropane and purchased as Desmosphen® 4011T by Bayer, 2 g of internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition P and Step c) of Reaction of Prepolymer 29 and Polyhydroxy Composition P

The polyhydroxy composition P was prepared according to Example 9. The polyhydroxy composition P was then heated to a temperature of 80° C. for at least 2 hours, under vacuum and stirring.

The prepolymer 29 of step a) was then cooled to 60° C. and poured in a vessel. The polyhydroxy composition P prepared as above indicated was cooled to 60° C. and poured in a second vessel. The prepolymer 29 of step a) was successively reacted with the composition in a ratio by weight of 2.1:1 of prepolymer 29 with respect to the polyhydroxy composition N. The reaction mass was then poured in a suitable mould and brought to a temperature of 60-110° C. in two hours and maintained for 1 hour at 110° C. After about three hours from the beginning of the reaction, the polyurethane 37 was completely hardened.

### EXAMPLE 12

### Preparation of Polyurethane 38 by the Process According to the Preferred Embodiment of the Invention

Step a) Preparation of the Prepolymer 30

84 g of 4,4′-methylenebis(cyclohexylisocyanate), commercially available as Desmodur W® from Bayer AG, were reacted with 16 g of polyalkylenecarbonate diol having a molecular weight of 760 and a functionality of 2, purchased as Ravecarb 104® by Polimeri Europa. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) Preparation of the Polyhydroxy Composition

97.5 g of trimethylolpropane ethoxylated having functionality of 3, purchased as Polyol TP08® (PM170) by Perstorp were mixed with 2 g of internal release agent consisting in mono-dialkylester phosphate and purchased as Int 1681 OG® by Axel, 0.2 g of blueing agent, whose formulation was as follows: 10 g of Sandoplast Violetto RSB® from Clariant dispersed in 10 kg of Desmophen 4011®T from Bayer, and 0.3 g of catalyst consisting in phenylmercuryneodecanoate purchased as Thorcat 535® by Thor Especialidades. The obtained polyhydroxy composition Q was then heated at temperature of 80° C. for at least 2 hours, under vacuum and stirring.

Step c) of Reaction of the Prepolymer 30 with the Polyhydroxy Composition Q

The prepolymer 30 of step a) was then cooled to 60° C. and poured in a vessel. The polyhydroxy composition Q prepared as above indicated was cooled to 60° C. and poured in a second vessel. The prepolymer 30 of step a) was successively reacted with the composition in a ratio by weight of 3:1 of prepolymer 30 with respect to the polyhydroxy composition Q. The reaction mass was then poured in a suitable mould and brought to a temperature of 60-110° C. in two hours and maintained for 1 hour at 110° C. After about three hours from the beginning of the reaction, the polyurethane 38 was completely hardened.

### EXAMPLE 13

### Preparation of Polyurethane 39 by the Process According to the Preferred Embodiment of the Invention

Step a) Preparation of the Prepolymer 31

89 g of 4,4′-methylenebis(cyclohexylisocyanate), commercially available as Desmodur W® from Bayer AG, were reacted with 2 g of polyalkylenecarbonate diol having a molecular weight of 760 and a functionality of 2, purchased as Ravecarb 104® by Polimeri Europa, 7 g of polyoxyalkylenetriol of molecular weight of 306 and functionality of 3, obtained by the condensation of propylene oxide with starter of trimethylolpropane and purchased as Desmosphen® 4011T by Bayer, 2 g of internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition Q and Step c) of Reaction of Prepolymer 31 and Polyhydroxy Composition Q

The polyhydroxy composition Q was prepared according to Example 12. The polyhydroxy composition Q was then heated to a temperature of 80° C. for at least 2 hours, under vacuum and stirring.

The prepolymer 31 of step a) was then cooled to 60° C. and poured in a vessel. The polyhydroxy composition Q prepared as in example 12 was cooled to 60° C. and poured in a second vessel. The prepolymer 31 of step a) was successively reacted with the composition in a ratio by weight of 3:1 of prepolymer 31 with respect to the polyhydroxy composition Q. The reaction mass was then poured in a suitable mould and brought to a temperature of 60-110° C. in two hours and maintained for 1 hour at 110° C. After about three hours from the beginning of the reaction, the polyurethane 39 was completely hardened.

### EXAMPLE 14

### Preparation of Polyurethane 40 by the Process According to the Preferred Embodiment of the Invention

Step a) Preparation of the Prepolymer 32

90 g of 4,4′-methylenebis(cyclohexylisocyanate), commercially available as Desmodur W® from Bayer AG, were reacted with 8 g of polyoxyalkylenetriol of molecular weight of 306 and functionality of 3, obtained by the condensation of propylene oxide with starter of trimethylolpropane and purchased as Desmosphen® 4011T by Bayer, 2 g of internal release agent consisting in mono-dialkylester phosphate and purchased as Int 1681 OG® by Axel. In the vessel, an amount of 75% of polyol was added and under stirring, isocyanate was subsequently and slowly added. The reaction has been prosecuted for 4 hours at 90° C., under vacuum and stirring. The percentage of free isocyanate groups was then monitored, thus adding the remaining about 25% of polyhydroxy compound. At the end of the addition and of the further reaction, the percentage of free NCO (% NCO) was measured, through the method indicated in Example 1, as being about 25%. Once the prepolymer was obtained, the monomer was removed so that the related amount was lower than 0.1% in the prepolymer.

Step b) of Preparation of the Polyhydroxy Composition Q and Step c) of Reaction of Prepolymer 32 and Polyhydroxy Composition Q

The polyhydroxy composition Q was prepared according to Example 12. The polyhydroxy composition Q was then heated to a temperature of 80° C. for at least 2 hours, under vacuum and stirring.

The prepolymer 32 of step a) was then cooled to 60° C. and poured in a vessel. The polyhydroxy composition Q prepared as in the example 12 was cooled to 60° C. and poured in a second vessel. The prepolymer 32 of step a) was successively reacted with the composition in a ratio by weight of 3:1 of prepolymer 32 with respect to the polyhydroxy composition Q. The reaction mass was then poured in a suitable mould and brought to a temperature of 60-110° C. in two hours and maintained for 1 hour at 110° C. After about three hours from the beginning of the reaction, the polyurethane 40 was completely hardened.

### EXAMPLE 15

### Evaluation of Curing Times on the Basis of Casting Temperatures

The prepolymer 24 as obtained in Example 6 was reacted to polyhydroxy composition N by using glass or nickel moulds and constant or linearly increasing temperature during curing. The values reported in Table 5 were obtained.

TABLE 5

| Curing | | | | |
|---|---|---|---|---|
| temperature | Curing cycle | Mould material | Curing time | |
| 60° C. | Constant temperature | glass | 45 | h |
| 80° C. | Constant temperature | glass | 8 | h |
| 60 → 110° C. | Temperature linear ramp | glass | 2 | h |
| 110° C. | Constant temperature | nickel | 20 | min. |
| 130° C. | Constant temperature | nickel | 4 | min. |
| 150° C. | Constant temperature | nickel | 1 | min. |

As shown in Table 5, a wide range of temperatures for casting can be used. Particularly, it was demonstrated that temperatures can be highly increased, up to 100° C., in order to obtain hardened polyurethanes within times of a few minutes. This makes the invention suitable for fast casting systems.

### EXAMPLE 16

### Evaluation of Polyurethanes 32-40

The polyurethanes 32-40 were evaluated on the basis of the properties thereof. For all the polyurethanes 32-40, the following features were measured:
the heat distortion temperature (HDT) under load according to standard procedure ASTM D-648;
the Rockwell Hardness (HRC) measured by a Rockwell durometer according to standard procedure ASTM D-785;
the light transmission according to standard procedure ASTM D-1003; and
the Izod impact strength according to modified standard procedure ASTM 256.

The values reported in the following Table 6 were obtained:

TABLE 6

| | HDT | Rockwell | Transmission | Izod impact |
|---|---|---|---|---|
| Polyurethane | (° C.) | Hardness | (%) | strength (KJ/m²) |
| 32 | 64.5 | 102 | >90 | >100 |
| 33 | 67.5 | 96 | >90 | >100 |
| 34 | 70.2 | 106 | >90 | >100 |
| 35 | 72.1 | 107 | >90 | >100 |
| 36 | 74.3 | 107 | >90 | >100 |
| 37 | 82.8 | 110 | >90 | >100 |
| 38 | 84.2 | 112 | >90 | >100 |
| 39 | 87.4 | 114 | >90 | >100 |
| 40 | 90.1 | 116 | >90 | >100 |

As shown in Table 6, the polyurethanes according to the preferred embodiments have optimal light transmission properties, showing at the same time high Rockwell hardnesses (HRC) and good HDT. As far as the impact strength is concerned, the measured strength was five times higher than the value of about 34-42 of the polycarbonate obtained by the polymerization of diethylene glycol bisallyl carbonate (ADC), as referred in PCT International application, publication n. WO00/27794. Therefore according to the present invention, transparent polyurethanes suitable for optical applications can be obtained by this preferred embodiment.

### EXAMPLE 17

### Comparative Example Between the Polyurethane 32 and the Prior Art Transparent Polyurethanes

The polyurethane 32 obtained by the Example 6 was compared to the polyurethane obtained by the reaction of isocyanates with aromatic amines, as described in prior art and purchased as Trivex® by PPG Industries Inc., and to the polycarbonate obtained by polymerization of diethylene bisallyl carbonate (ADC). Such prior art compounds are known for their optimal transparency which allows the use in optical field.

The three cured compounds were compared by measuring:
haze value (%) of the cured polymers corresponding to the percentage of diffused transmitted light by the total transmitted light according to the procedure ASTM D-1003;
initial yellow index defined as chromatic deviation from the water colour according to the procedure ASTM D-1925;
yellow index defined as chromatic deviation from the water colour according to the procedure ASTM D-1925 after 1 month of outdoor exposure.

The values reported in Table 7 were obtained.

TABLE 7

| | Haze | Initial | Yellow index after 1 month |
|---|---|---|---|
| Material | value (%) | yellow index | of outdoor exposure |
| ADC | 0.2 | 1.0 | 1.1 |
| Trivex ® | 1.0 | 0.2 | 0.9 |
| Polyurethane 32 | 0.2 | 0.2 | 0.1 |

As shown in Table 7, the polyurethane 32 according to the present invention had the same haze value as the polycarbonate ADC, but compared to this one, the polyurethane 32 showed a low initial yellow index, which was comparable to the value of Trivex®, being this polyurethane obtained by the reaction with aromatic amines. The yellow index after 1 month of outdoor exposure resulted optimal with respect to that one of Trivex®, which yellowed because of the reaction of the aromatic amines with the air oxygen.

### EXAMPLE 18

### Comparative Example Between the Polyurethane 33 and the Prior Art Polycarbonates for the Determination of Percent Shrinkage During Curing

The polyurethane 33 of the example 7 was compared to two samples of Polycarbonate obtained by polymerization of diethylene bisallyl carbonate (ADC), purchased as RAV-7® by Great Lakes Chemical Corporation, with a peroxide according to the procedures indicated in International applications, publication n. WO99/17137 and WO00/27794, respectively. The evaluation consisted in the determination of shrinkage percentage during curing by measuring polymer linear shrinkage of flat, 19 mm thick, hockey puck-shaped articles. The percent variation was on-line measured during casting, which was carried out in two different curing cycles:
constant temperature of 80° C.;
increasing temperature from 60 to 110° C.

The observed shrinkages, as well as the curing times, are listed in Table 8.

TABLE 8

| | | Curing | Shrinkage |
|---|---|---|---|
| Material | Temperature (° C.) | time | (%) |
| Polycarbonate | constant 80° C. | 21 h | 12.3 |
| WO9917137 | during curing | | |
| Polycarbonate | constant 80° C. | 18 h | 10.3 |
| WO0027794 | during curing | | |
| Polyurethane 33 | constant 80° C. | 2 h | 1.4 |
| | during curing | | |
| Polyurethane 33 | increasing temperature from | 2 h | 0.5 |
| | 60 to 110° C. during curing | | |

As shown in Table 8, the polyurethane of the invention, with respect to the prior art polycarbonates, had very low shrinkage percentages during curing at constant temperature and much lower shrinkage percentages in case of increasing cycle temperature during curing.

This optimal property, showed by the material, makes it particularly suitable for lens formation having complex shapes to be obtained, such as bifocal, trifocal or progressive lenses, since flexible gaskets, which are able to compensate the polymer

1-44. (canceled)

45. A process for the preparation of polyurethanes comprising the following steps:
a) preparing a prepolymer by reacting one or more aliphatic or cycloaliphatic isocyanates, having two or more isocyanate groups, and one or more polyhydroxy compounds selected from the group consisting of polyether polyols and polycarbonate polyols;
b) preparing a composition comprising one or more polyhydroxy compounds, which consist in polyether polyols, and a suitable catalyst; and
c) reacting the prepolymer of step a) and the composition of step b),
wherein,
at the end of step a), the percentage of free isocyanate groups in the prepolymer is at least 15%, and with the proviso that:
when the polyhydroxy compounds of step a) or step b) or both are polyether polyols, they are, independently from each other, one or more from a product of condensation of ethylene oxide and/or propylene oxide with a starter of trimethylolpropane having molecular weight from 200 to 600, and trimethylolpropane ethoxylated;
when the polyhydroxy compounds of step a) are polycarbonate polyols, they are, independently from each other, a product of esterification of dimethylcarbonate with a diol having from 5 to 10 carbon atoms and having molecular weights from 600 to 900.

46. The process according to claim 45, wherein the percentage of free isocyanate groups in the prepolymer is from 15 to 30%.

47. The process according to claim 46, wherein the percentage of free isocyanate groups in the prepolymer is from 20 to 25%.

48. The process according to any one of claim 45, wherein one or more cycloaliphatic isocyanates are selected from the group consisting of 4,4′-methylenbis(cyclohexylisocyanate), isophorondiisocyanate, 2,5(6)-diisocyanate-methylbicyclo(2.2.1)heptane and bis(isocyanatemethyl)cyclohexane.

49. The process according to claim 48, wherein the cycloaliphatic isocyanate is 4,4′-methylenbis(cyclohexylisocyanate) or isophorondiisocyanate.

50. The process according to claim 49, wherein the cycloaliphatic isocyanate is 4,4′-methylenbis(cyclohexylisocyanate).

51. The process according to claim 45, wherein the polyether polyol is a polyoxyalkylenetriol obtained by condensation of propylene oxide with a starter of trimethylolpropane having a molecular weight of about 300.

52. The process according to claim 45, wherein the polycarbonate polyol has a molecular weight from 750 to 850.

53. The process according to claim 45, wherein the catalyst of step b) is an amine or metal catalyst.

54. The process according to claim 53, wherein the catalyst is a metal catalyst, preferably phenylmercuryneodecanoate.

55. The process according to claim 45, where in step a) or step b) or both one or more additives are added, selected from the group consisting of internal release agents, lubricants, blue and violet blueing agents, dyes, nanoparticles, UV absorbers, light stabilizers and antioxidants.

56. The process according to claim 55, wherein the internal release agents are one or more elements selected from the group consisting of fluoropolymer, di-n-alkyl-phosphate, polydimethyl-siloxane, alkanol acid phosphate, ammonium salt, mono-dialkylester phosphate and alkyltiophosphate.

57. The process according to claim 56, wherein the internal release agent is mono-dialkylester phosphate.

58. The process according to claim 45, wherein the ratio by weight between the prepolymer of step a) and the ingredients of step b) is preferably from 1:1 to 3:1.

59. The process according to claim 45, wherein
the prepolymer is obtained from the reaction of 4,4′-methylenbis(cyclohexylisocyanate) with one or more polyhydroxy compounds of step a) selected from the group consisting of polyalkylenecarbonate diol having a molecular weight from 600 to 800 and polyoxyalkylenetriol having a molecular weight from 200 to 400, and
the composition of step b) comprises one or more polyhydroxy compounds selected from the group consisting of polyoxyalkylenetriol having a molecular weight from 200 to 400 and trimethylolpropane ethoxylated.

60. The process according to claim 59, wherein the composition of step b) comprises a catalyst as defined in claim 53 or in claim 54, and additives as defined in claim 55 or 56.

61. The process according to claim 60, wherein either the polyhydroxy compounds of step b) or of both step a) and step b) are added with an internal release agent consisting of mono-dialkylester phosphate.

62. The process according to claim 59, wherein the percentage of free isocyanate groups in the prepolymer at the end of step a) is equal or higher than 20%, more preferably is about 25%.

63. The process according to claim 59, wherein the prepolymer reacts with the composition of step b) in a ratio from 3:1 to 1.5:1 of prepolymer with respect to the composition of step b).

64. The process according to claim 45, wherein the synthesis of the prepolymer of step a) occurs at temperatures from 90 to 110° C., the preparation of the composition of step b) occurs at temperatures from 40 to 100° C. and the reaction of step c) occurs at temperatures from 50 to 150° C.

65. A composition for the preparation of polyurethanes through catalytic polymerization comprising:
part a): a prepolymer obtained by reacting one or more isocyanates and one or more polyhydroxy compounds and having a percentage of free isocyanate groups of at least 15%; and
part b): one or more polyhydroxy compounds and a catalyst,
wherein part a) comprises a prepolymer obtained by the reaction of one or more isocyanates, as defined in claim 48, and one or more polyhydroxy compounds, as defined in claim 45, and wherein part b) comprises one or more polyhydroxy compounds, as defined in claim 45, and a catalyst, as defined in claim 53.

66. The composition according to claim 65, wherein the percentage of free isocyanate groups of the prepolymer of part a) is from 15 to 30%, more preferably from 20 to 25%.

67. The composition according to claim 65, wherein part a) or part b) or both comprises one or more additives as defined in claim 55.

68. A polyurethane obtainable by the process according to claim 45.

69. The polyurethane according to claim 68, having a heat distortion temperature (HDT) ranging from 60 to 110° C.

70. The polyurethane according to claim 68, wherein the polyurethane has a volume shrinkage during curing lower than 2%.

71. An article made of the polyurethane according to claim 68, wherein the article is selected from the group consisting of building or automobile windows, automobile headlamp covers, ophthalmic lenses, sun lenses, protective goggles, face shields, light guides, optical fibers, mobile phone components, lenses for optical storage devices, prisms, Fresnel lenses, display covers, solar cells, optical sensor covers, transparent pipes, and furniture, windows for cinemas and performances in general.

72. The article according to claim 71, wherein the article is a lens.
